(19) United States
(12) Patent Application Publication
(10) Pub. No.: US 2023/0042510 A1
(43) Pub. Date: Feb. 9, 2023

(54) MEDIUM CONVEYANCE DEVICE

(71) Applicant: PFU Limited, Ishikawa (JP)

(72) Inventors: Junya MIYAMOTO, Ishikawa (JP); Tomohiro Murakami, Ishikawa (JP)

(21) Appl. No.: 17/856,281

(22) Filed: Jul. 1, 2022

(30) Foreign Application Priority Data
Aug. 4, 2021 (JP) 2021-128021

(51) Int. Cl. B65H 7/06; H04N 1/00

(52) U.S. Cl. CPC B65H 7/06; H04N 1/00705; H04N 1/00602; H04N 1/00774; H04N 1/00631; H04N 1/00801; B65H 2601/254; H04N 1/00734

(57) ABSTRACT

A medium conveyance device includes a conveyor configured to convey a medium along a conveyance path, a first sensor configured to detect whether or not the medium is disposed is a detection region in the conveyance path, and a controller configured to control the conveyor to convey the medium in an ejection direction opposite to a feed direction when the conveyor conveys the medium in the feed detection and when the first sensor no longer detects the medium, wherein the controller controls the conveyor to convey the medium in the ejection direction when the conveyor keeps the medium stopped and when the first sensor no longer detects the medium.

### CROSS-REFERENCE TO RELATED APPLICATION

This application is based upon and claims the benefit of priority of the prior Japanese Patent Application. No. 2021-128021, filed on Aug. 4, 2021, the entire contents of which are incorporated herein by reference.

### FIELD

The technology according to the present disclosure relates to a medium conveyance device.

### BACKGROUND

There are known medium conveyance devices each enabling a reduction in the load to a medium when the medium supported by the device is pulled from the device (refer to Japanese Laid-open Patent Publication No. 60-223746, Japanese Laid-open Patent Publication No. 2007-136745, and Japanese Laid-open Patent Publication No. 2014-133317).

Such a medium conveyance device includes a special-purpose sensor that detects whether a medium has been pulled from the device, leading to an increase in manufacturing cost as a problem.

### SUMMARY

According to an aspect of an embodiment, a medium conveyance device includes a conveyor configured to convey a medium along a conveyance path, a first sensor configured to detect whether or not the medium is disposed in a detection region in the conveyance path, and a controller configured to control the conveyor to convey the medium in an ejection direction opposite to a feed direction when the conveyor conveys the medium in the feed direction and when the first sensor no longer detects the medium, wherein the controller controls the conveyor to convey the medium in the ejection direction when the conveyor keeps the medium stopped and when the first sensor no longer detects the medium.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a schematic sectional view of an image reading apparatus including a medium conveyance device according to an embodiment;

FIG. 2 is a block diagram of the image reading apparatus;

FIG. 3 is a flowchart of the operation of the image reading apparatus;

FIG. 4 is a schematic sectional view of the image reading apparatus having an insertion/ejection opening in which a medium has been inserted;

FIG. 5 is a schematic sectional view of the image reading apparatus with the medium having its feed-side end having passed through a position detection region;

FIG. 6 is a schematic sectional view of the image reading apparatus with the medium having its ejection-side end having passed through the position detection region;

FIG. 7 is a schematic sectional view of the image reading apparatus with the medium having its feed-side end having passed through the position detection region; and

FIG. 8 is a schematic sectional view of the image reading apparatus with the medium having been pulled in an ejection direction.

### DESCRIPTION OF EMBODIMENTS

Preferred embodiments of the disclosure will be explained with reference to accompanying drawings medium conveyance device according to an embodiment disclosed in the present application will be described below with reference to the drawings. Note that the technology according to the present disclosure is not limited to the following description. In the following description, the same constituent elements are denoted with the same reference signs, and duplicate descriptions thereof will be omitted.

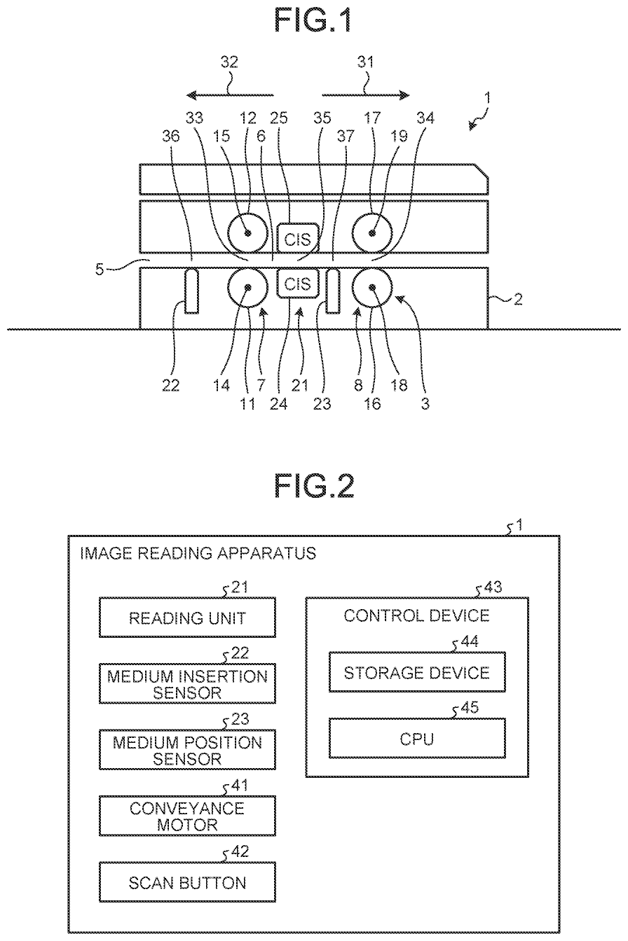

As illustrated in FIG. 1, the medium conveyance device according to the embodiment is provided in an image reading apparatus 1. FIG. 1 is a schematic sectional view of the image reading apparatus 1 including the medium conveyance device according to the embodiment. The image reading apparatus 1 includes a medium conveyance device body 2 and a conveyance unit 3. The medium conveyance device body 2 has an insertion/ejection opening 5 and a conveyance path 6. The conveyance path 6 is substantially flat inside the medium conveyance device body 2. A plane along the conveyance bath 6 is substantially parallel to a plane along the installation face on which the medium conveyance device body 2 is installed. The insertion/ejection opening 5 is located at the upstream end in a feed direction 31 of the medium conveyance device body 2. The feed direction 31 is parallel to the plane along the conveyance path 6. The conveyance path 6 is in communication with the outside of the medium conveyance device body 2 through the insertion/ejection opening 5.

The conveyance unit 3 is disposed inside the medium conveyance device body 2. The conveyance unit 3 includes a pair of ejection-side rollers 7 and a pair of feed-side rollers 8. The pair of ejection-side rollers 7 is disposed near an ejection-side support region 33 in The conveyance path 6 and includes a conveyance roller 11 and a pinch roller 12. The conveyance roller 1 disposed below the ejection-side support region 33 and is supported rotatably around a rotation axis 14 by the medium conveyance device body 2. The rotation axis 14 is parallel to the plane along the conveyance path 6 and is orthogonal to the feed direction 31. The pinch roller 12 is disposed above the ejection-side support region 33 and is supported rotatably around a rotation axis 15 by the medium conveyance device body 2. The rotation axis 15 is parallel to the rotation axis 14. The pinch roller 12 is in contact with the conveyance roller 11.

The pair of feed-side rollers 8 is disposed near a feed-side support region 34 in the conveyance path 6. The feed-side support region 34 is disposed downstream of the ejection-side support region 33 in the feed direction 31. That is, the ejection-side support region 33 is disposed between the insertion/ejection opening 5 and the feed-side support region 34. The pair of feed-side rollers 8 includes a conveyance roller 16 and a pinch roller 17. The conveyance roller 16 is disposed below the feed-side support region 34 and is supported rotatably around a rotation axis 18 by the medium conveyance device body 2. The rotation axis 18 is parallel to the rotation axis 14. The pinch roller 17 is disposed above the feed-side support region 34 and is supported rotatably around a rotation axis 19 by the medium conveyance device body 2. The rotation axis 19 is parallel to the rotation axis 18. The pinch roller 17 is in contact with the conveyance roller 16.

The image reading apparatus 1 further includes a reading unit 21, a medium insertion sensor 22, and a medium position sensor 23. The reading unit 21 is disposed near a reading region 35 in the conveyance path 6. The reading region 35 is disposed between the ejection-side support region 33 and the feed-side support region 34. The reading unit 21 includes a lower reading unit 24 and an upper reading unit 25. The lower reading unit 24 is formed of a contact image sensor (CIS) type of image sensor. The lower reading unit 24 is disposed below the reading region 35. The lower reading unit 24 captures an image on the lower face of a portion of a medium being conveyed along the conveyance path 6, the portion being disposed in the reading region 35. The upper reading unit 25 is formed of a CIS type of image sensor. The upper reading unit 25 is disposed above the reading region 35 such that the upper reading unit 25 and the lower reading unit 24 face through the reading region 35. The upper reading unit 25 captures an image on the upper face of a portion of a medium being conveyed along the conveyance path 6, the portion being disposed in the reading region 35.

The medium insertion sensor 22 is disposed near an insertion detection region 36 in the conveyance path 6. The insertion detection region 36 is disposed between the insertion/ejection opening 5 and the ejection-side support region 33 and is disposed upstream of the ejection-side support region 33 in the feed direction 31. The medium insertion sensor 22 projects light to the insertion detection region 36, to optically detect whether or not a medium is disposed in the insertion detection region 36. The medium position sensor 23 is disposed near a position detection region 37 in the conveyance path 6. The position detection region 37 is disposed between the feed-side support region 34 and the reading region 35. That is, the ejection-side support region 33 is disposed upstream of the position detection region 37 in the feed direction 31 in the conveyance path 6. The feed-side support region 34 is disposed downstream of the position detection region 37 in the feed direction 31 in the conveyance path 6. The medium position sensor 23 projects light to the position detection region 37, to optically detect whether or not a medium is disposed in the position detection region 37.

FIG. 2 is a block diagram of the image reading apparatus 1. The image reading apparatus 1 further includes a conveyance motor 41, a scan button 42, and a control device 43. The conveyance motor 41 is disposed inside the medium conveyance device body 2. The conveyance motor 41 brings the conveyance roller 11 and the conveyance roller 16 into forward rotation or reverse rotation or stops the rotation of the conveyance roller 11 and the conveyance roller 16. The scan button 42 is exposed outward from the medium conveyance device body 2 and is fixed to the medium conveyance device body 2. The scan button 42 detects whether or not the scan button 42 has been pressed.

The control device 43 is a computer and includes, for example, a storage device 44 and a central processing unit (CPU) 45. The storage device 44 stores a computer program installed in the control device 43 and stores information to be used by the CPU 45. The CPU 45 executes the computer program installed in the control device 43 to perform information processing, control the storage device 44, and control the reading unit 21, the medium insertion sensor 22, the medium position sensor 23, the conveyance motor 41, and the scan button 42.

The control device 43 controls the medium insertion sensor 22 to monitor whether or not a medium is disposed in the insertion detection region 36. The control device 43 controls the medium position sensor 23 to monitor whether or not a medium is disposed in the position detection region 37. The control device 43 controls the conveyance motor 41 to bring the conveyance roller 11 and the conveyance roller 16 into forward rotation. (clockwise rotation in FIG. 1) or reverse rotation (counterclockwise rotation in FIG. 1) or to stop the rotation of the conveyance roller 11 and the rotation of the conveyance roller 16. The control device 43 controls the scan button 42 to monitor whether or not the scan button 42 has been pressed. The control device 43 controls the reading unit 21 to read an image on the lower face of a medium being conveyed along the conveyance path 6 and an image on the upper face of the medium being conveyed along the conveyance path 6.

### Operation of Image Reading Apparatus 1

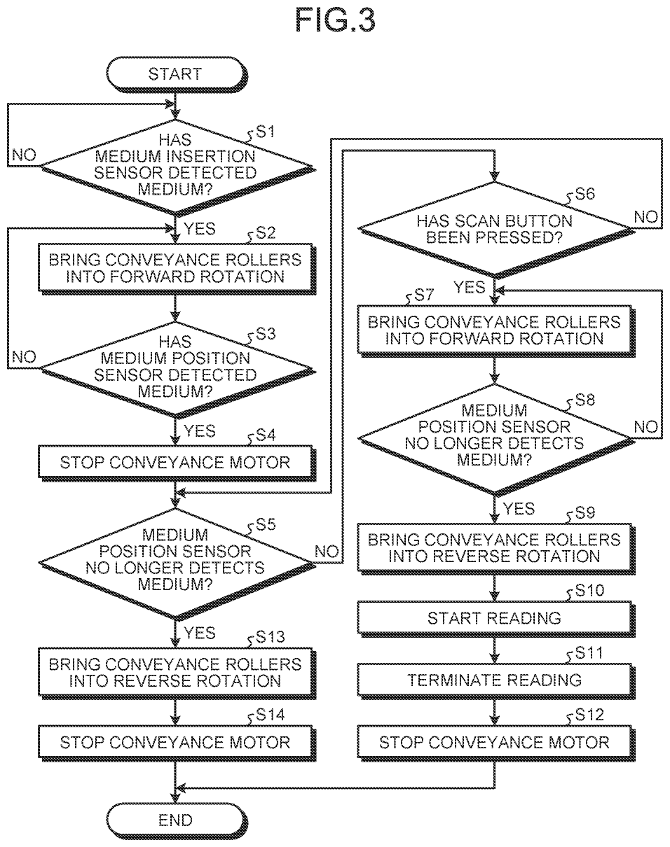

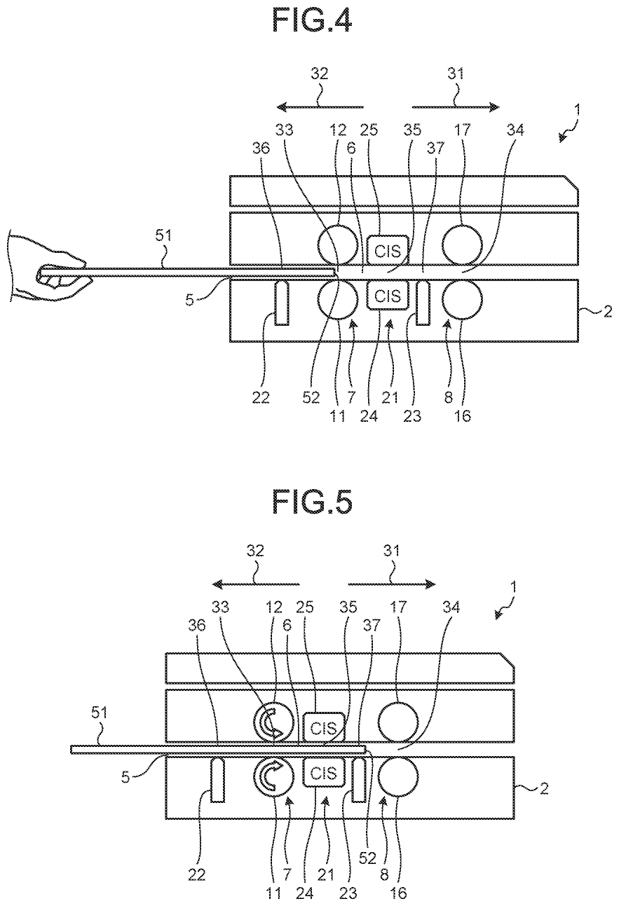

FIG. 3 is a flowchart of the operation of the image reading apparatus 1. Initially, the control device 43 keeps the conveyance motor 41 stopped and thus keeps the conveyance roller 11 and the conveyance roller 16 in non-rotation. Furthermore, the control device 43 controls the medium insertion sensor 22 to monitor to whether or not a medium is disposed in the insertion detection region 36 (Step S1). As illustrated in FIG. 4, in order to read an image on a medium 51 with the image reading apparatus 1, a user inserts the medium 51 properly into the insertion/ejection opening 5 such that a feed-side end 52 of the medium 51 is in contact with the pair of ejection-side rollers 7. FIG. 4 is a schematic sectional view of the image reading apparatus 1 having the insertion/ejection opening 5 in which the medium 51 has been inserted. With the medium 51 inserted properly in the insertion/ejection opening 5, part of the medium 51 is disposed in the insertion detection region 36.

Due to the part of the medium 51 disposed in the insertion detection region 36, the medium insertion sensor 22 detects the medium 51. In response to detection of the medium 51 by the medium insertion sensor 22 with the conveyance unit 3 having not conveyed the medium 51 (Step S1: Yes), the control device 43 drives the conveyance motor 41 to bring the conveyance roller 11 and the conveyance roller 16 into forward rotation (Step S2). When the conveyance roller 11 rotates forward, the pinch roller 12 rotates forward (rotates counterclockwise in FIG. 4) following the conveyance roller 11. When the conveyance roller 16 rotates forward, the pinch roller 17 rotates forward (rotates counterclockwise in FIG. 4) following the conveyance roller 16. In response to detection of the medium 51 by the medium insertion sensor 22 (Step S1: Yes), the control device 43 further controls the medium position sensor 23 to monitor whether or not the medium 51 is disposed in the position detection region 37 (Step S3).

Due to forward rotation of the conveyance roller 11 with the feed-side end 52 in contact with the pair of ejection-side rollers 7, the medium 51 is pinched between the conveyance roller 11 and the pinch roller 12 and then is supported by the pair of ejection-side rollers 7. Due to forward rotation of the conveyance roller 11 with the medium 51 supported by the pair of ejection-side rollers 7 the conveyance unit 3 conveys the medium 51 in the feed direction 31 along the conveyance path 6. As illustrated in FIG. 5, due to conveyance of the medium 51 in the feed direction 31, the feed-side end 52 of the medium 51 passes through the reading region 35 and the position detection region 37, so that part of the medium 51 is disposed in the position detect _on region 37. FIG. 5 is a schematic sectional view of the image reading apparatus 1 with the medium 51 having the feed-side end 52 having passed through the position detection region 37.

Due to the part of the medium 51 disposed in the position detection region 37, the medium position sensor 23 changes from the non-detection state in which no medium 51 has been detected to the detection state in which the medium 51 has been detected, resulting in detection of the medium 51. In response to detection of the medium 51 by the medium position sensor 23 with the conveyance unit 3 conveying the medium 51 in the feed direction 31 (Step S3: Yes), the control device 43 stops the conveyance motor 41 (Step 54). The stop of the conveyance motor 41 stops the rotation of the conveyance roller 11 and the rotation of the conveyance roller 16, so that the conveyance unit 3 stops the conveyance of the medium 51 before the feed-side end 52 of the medium 51 comes in contact with the pair of feed-side rollers 8.

In a case where the medium position sensor 23 has been detecting the medium 51 with the conveyance unit 3 keeping the medium 51 in non-conveyance (Step S5: No), the control device 43 controls the scan button 42 to monitor whether or not the scan button 42 has been pressed (Step 36). With the medium 51 supported by the pair of ejection-side rollers 7 and with the conveyance unit 3 keeping the medium 51 in non-conveyance, the user presses the scan button 42. When it is detected that the scan button 42 has been pressed (Step 56: Yes), the control device 43 drives the conveyance motor 41 to bring the conveyance roller 11 and the conveyance roller 16 into forward rotation (Step 57). Due to forward rotation of the conveyance roller 11 with the medium 51 supported by the pair of ejection-side rollers 7, the conveyance unit 3 conveys the medium 51 in the feed direction 31 along the conveyance path 6, so that the feed-side end 52 of the medium 51 comes in contact with the pair of feed-side rollers 8. Due to contact of the feed-side end 52 with the pair of feed-side rollers 8 during forward rotation of the conveyance roller 16, the medium 51 is pinched between the conveyance roller 16 and the pinch roller 17 and then is supported by the pair of feed-side rollers 8. Due to forward rotation of the conveyance roller 16 with the medium 51 supported by the pair of feed-side rollers 8, the conveyance unit 3 further conveys the medium 51 in the feed direction 31 along the conveyance path 6.

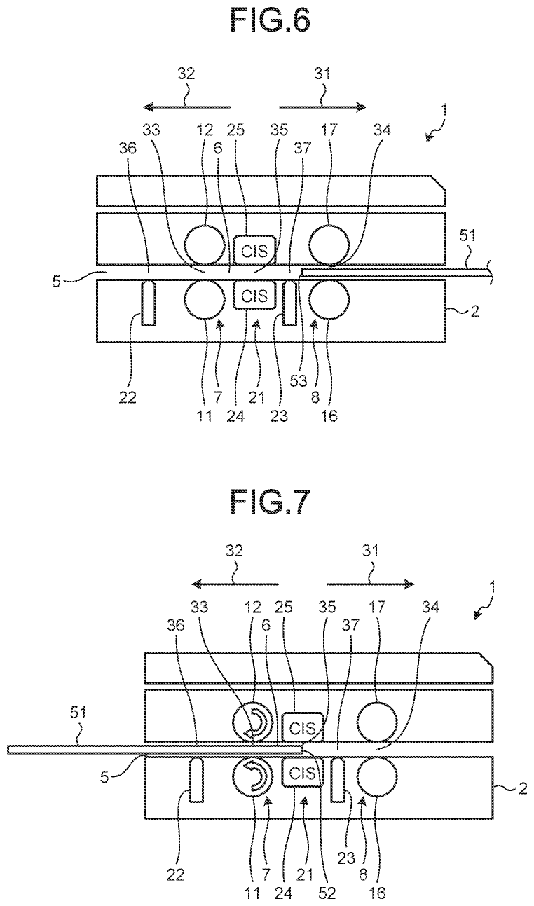

As illustrated in FIG. 6, due to conveyance of the medium 51 in the feed direct on 31, an ejection-side end 53 that the medium 51 has opposite the feed-side end 52 passes through the position detection region 37, so that the medium 51 is removed from the position detection region 37. FIG. 6 is a schematic sectional view of the image reading apparatus 1 with the medium 51 having the ejection-side end 53 having passed through the position detection region 37. Due to removal of the medium 51 from the position detection region 37, the medium position sensor 23 changes from the detection state to the non-detection state, resulting in no detection of the medium 51. In response to no detection of the medium 51 by the medium position sensor 23 with the conveyance unit 3 conveying the medium 51 in the feed direction 31 (Step S8: Yes), the control device 43 brings the conveyance roller 11 and the conveyance roller 16 into reverse rotation, with the conveyance motor 41 (Step S9). When the conveyance roller 11 rotates reversely, the pinch roller 12 rotates reversely (rotates clockwise in FIG. 6) following the conveyance roller 11. When the conveyance roller 16 rotates reversely, the pinch roller 17 rotates reversely (rotates clockwise in FIG. 6) following the conveyance roller 16.

Due to reverse rotation of the conveyance roller 16 with the medium 51 supported by the pair of feed-side rollers 8, the conveyance unit 3 conveys the medium 51 in an ejection direction 32 opposite to the feed direction 31, so that the ejection-side end 53 of the medium 51 passes through the position detection region 37 and then passes through the reading region 35. Due to passage of the ejection-side end 53 of the medium 51 through the position detection region 37, the medium position sensor 23 changes from the non-detection state to the detection state, resulting in detection of the medium 51. In response to detection of the medium 51 by the medium position sensor 23 with the conveyance unit 3 conveying the medium 51 in the ejection direction 32, the control device 43 controls the reading unit 21 to start reading at the reading start timing in order to read an image on the medium 51 (Step S10). The reading start timing corresponds to the front-end passage timing at which the medium position sensor 23 changes from the non-detection state to the detection state during reverse rotation of the conveyance roller 16. For example, the time from the front-end passage timing to the reading start timing is identical to a previously determined reading-start standby time.

As illustrated in FIG. 7, due to conveyance of the medium 51 in the ejection direction 32, the feed-side end 52 of the medium 51 passes through the position detection region 37. FIG. 7 is a schematic sectional view of the image reading apparatus 1 with the medium 51 having the feed-side end 52 having passed through the position detection region 37. Due to passage of the feed-side end 52 of the medium 51 through the position detection region 37, the medium position sensor 23 changes from the detection state to the non-detection state, resulting in no detection of the medium 51. In response to no detection of the medium 51 by the medium position sensor 23 with the conveyance unit 3 conveying the medium 51 in the ejection direction 32, the control device 43 controls the reading unit 21 to terminate the reading at the reading termination timing (Step S11). The reading termination timing corresponds to the rear-end passage timing at which the medium position sensor 23 changes from the detection state to the non-detection state during reverse rotation of the conveyance roller 16. For example, the time from the rear-end passage timing to the reading termination timing is identical to a previously determined reading-termination standby time. Due to reading from the reading start timing to the reading termination timing, the image reading apparatus enables proper reading of an image on the medium 51 such that the reading unit 21 captures the entire image on the medium 51. Furthermore, due to reading from the reading start timing to the reading termination timing, the image reading apparatus 1 enables minimalization of the duration of reading with the medium 51 having any part not disposed in the reading region 35.

The control device 43 stops the conveyance motor 41 at the ejection-time motor-stop timing later than the reading termination timing, so that the rotation of the conveyance roller 11 and the rotation of the conveyance roller 16 stop and then the conveyance of the medium 51 stops (Step S12). The ejection-time motor-stop timing corresponds to the rear-end passage timing at which the medium position sensor 23 changes from the detection state to the non-detection state during reverse rotation of the conveyance roller 11 and the conveyance roller 16. For example, the time from the rear-end passage timing to the ejection-time motor-stop timing is identical to a previously determined ejection-time motor-stop standby time. Due to the drive of the conveyance motor 41 until the ejection-time motor-stop timing, the image reading apparatus 1 enables reliable ejection of the medium 51. Due to the stop of the conveyance motor 41 at the ejection-time motor-stop timing, the image reading apparatus 1 enables minimization of the time during which the conveyance motor 41 is driving after ejection of the medium 51, so that a reduction can be made in power consumption.

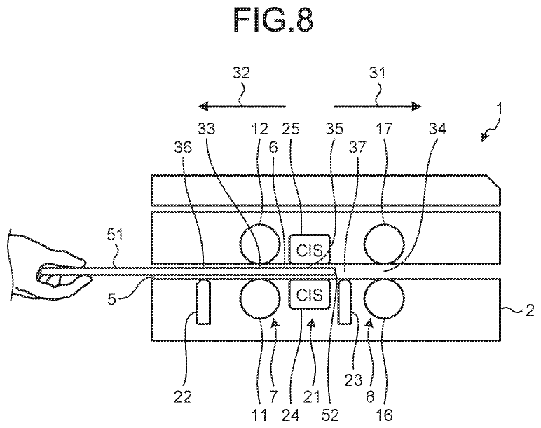

In some cases, the image reading apparatus 1 has the trouble that the medium 51 is supported improperly by the pair of ejection-side rollers 7. Examples of such a trouble are that the medium 51 is supported, at an angle with respect to the feed direction 31, by the pair of ejection-side rollers 7 and that the medium 51 is different from the medium from which the user desires to read an image. As illustrated in FIG. 8, with a trouble having occurred and with the conveyance unit 3 keeping the medium 51 in non-conveyance, the user pulls the medium 51 in the ejection direction 32. FIG. 8 is a schematic sectional view of the image reading apparatus 1 with the medium 51 having been pulled in the ejection direction 32. When the medium 51 is pulled in the ejection direction 32, the medium 51 moves in the ejection direction 32 against the frictional force acting between the medium 51 and the conveyance roller 11 and the feed-side end 52 of the medium 51 passes through the position detection region 37, so that the medium 51 is removed from the position detection region 37.

Due to removal of the medium 51 from the position detection region 37, the medium position sensor 23 changes from the detection state to the non-detection state, resulting in no detection of the medium 51. In response to no detection of the medium 51 by the medium position sensor 23 with the conveyance unit 3 keeps the medium 51 in non-conveyance (Step S5: Yes), the control device 43 drives the conveyance motor 41 to bring the conveyance roller 11 and the conveyance roller 16 into reverse rotation (Step S13).

Due to reverse rotation of the conveyance roller 11, the medium 51 is conveyed in the ejection direction 32, so that the medium 51 is released from the support by the pair of ejection-side rollers 7 and then is ejected through the insertion/ejection opening 5. At the pulling-time motor-stop timing after reverse rotation of the conveyance roller 11 and the conveyance roller 16, the control device 43 stops the conveyance motor 41 to stop the rotation of the conveyance roller 11 and the rotation of the conveyance roller 16 (Step S14). The pulling-time motor-stop timing corresponds to the pulling timing at which the medium position sensor 23 changes from the detection state to the non-detection state with the conveyance roller 11 in non-rotation. For example, the time from the pulling timing to the pulling-time motor-stop timing is identical to a previously determined pulling-time motor-stop standby time. Due to the drive of the conveyance motor 41 until the pulling-time motor-stop timing, the image reading apparatus 1 enables reliable ejection of the medium 51. Due to the stop of the conveyance motor 41 at the pulling-time motor-stop timing, the image reading apparatus 1 enables minimization of the time during which the conveyance motor 41 is driving after ejection of the medium 51, so that a reduction can be made in power consumption.

An image reading apparatus according to a comparative example does not perform the processing in Step S5, the processing in Step S13, and the processing in Step S14 in the operation of the image reading apparatus 1 already described. That is, in the image reading apparatus according to the comparative example, the conveyance roller 11 does not rotate reversely even when the medium 51 is pulled from the medium conveyance device body 2 with the conveyance roller 11 in non-rotation. Thus, in the image reading apparatus according to the comparative example, when the medium 51 is pulled from the medium conveyance device body 2, a large load is applied to the medium 51 by the frictional force between the medium 51 and the conveyance roller 11, so that a trouble may occur, such as damage to the medium 51.

In comparison to the image reading apparatus according to the comparative example, due to ejection of the medium 51 responsive to pulling of the medium 51 from the medium conveyance device body 2, the image reading apparatus 1 enables a reduction in the load to the medium 51, so that troubles can be prevented from occurring to the medium 51. Because the user does not need to pull the medium 51 until ejection of the medium 51 due to ejection of the medium 51 responsive to pulling of the medium 51 from the medium conveyance device body 2, the image reading apparatus 1 enables a reduction in the load when the user pulls the medium 51.

With the medium position sensor 23 for use in acquisition of a plurality of timings, the image reading apparatus 1 can detect whether the medium 51 has been pulled. The plurality of timings includes the timing at which the conveyance of the medium 51 in the feed direction 31 stops with the medium 51 supported by the pair of ejection-side rollers 7 and the timing at which the medium 51 being conveyed in the feed direction 31 is changed in direction for conveyance in the ejection direction 32. The plurality of timings further includes the reading start timing, the reading termination timing, the ejection-time motor-stop timing, and the pulling-time motor-stop timing. Thus, the image reading apparatus 1 requires no special-purpose sensor that detects whether the medium 51 has been pulled, separately from the medium position sensor 23, so that a reduction can be made in manufacturing cost without an increase in the number of components.

### Effects of Medium Conveyance Device According to Embodiment

The medium conveyance device according to the embodiment includes the conveyance unit 3, the medium position sensor 23, and the control device 43. The conveyance unit 3 conveys the medium 51 along the conveyance path 6. The medium position sensor 23 detects whether or not the medium 51 is disposed in the position detection region 37 in the conveyance path 6. In response to no detection of the medium 51 by the medium position sensor 23 with the conveyance unit 3 conveying the medium 51 in the feed direction 31, the control device 43 controls the conveyance unit 3 to convey the medium 51 in the ejection direction 32 opposite to the feed direction 31. Furthermore, in response to no detection of the medium 51 by the medium position sensor 23 with the conveyance unit 3 keeping the medium 51 stopped, the control device 43 controls the conveyance unit 3 to convey the medium 51 in the ejection direction 32.

The medium conveyance device according to the embodiment enables conveyance of the medium 51 in the ejection direction 32 responsive to pulling of the medium 51, so that a reduction can be made in the load to the medium 51 when the medium 51 is pulled. Furthermore, the medium conveyance device according to the embodiment detects whether or not the medium 51 has been pulled, with the medium position sensor 23 for acquisition of the timing at which the medium 51 being conveyed in the feed direction 31 is changed in direction for conveyance in the ejection direction 32. Thus, the medium conveyance device according to the embodiment requires no special-purpose sensor that detects whether or not the medium 51 has been pulled, so that a reduction can be made in manufacturing cost without an increase in the number of components.

In response to detection of the medium 51 by the medium position sensor 23 with the conveyance unit 3 conveying the medium 51 in the feed direction 31, the control device 43 of the medium conveyance device according to the embodiment controls the conveyance unit 3 to stop the conveyance of the medium 51. That is, the medium position sensor 23 is used for acquisition of the timing at which the conveyance of the medium 51 in the feed direction 31 stops with the medium 51 supported by the pair of ejection-side rollers 7. The medium conveyance device according to the embodiment requires no special-purpose sensor that detects whether or not the medium 51 has been pulled, separately from the medium position sensor 23 used for acquisition of such a timing, so that a reduction can be made in manufacturing cost.

The medium conveyance device according to the embodiment further includes the scan button 42 that detects a press on the scan button 42. In response to detection of a press on the scan button 42 by the scan button 42 with the conveyance unit 3 keeping the medium 51 stopped, the control device 43 controls the conveyance unit 3 to convey the medium 51 in the feed direction 31. The medium conveyance device according to the embodiment enables conveyance of the medium 51 in the ejection direction 32 responsive to pulling of the medium 51 during standby for a press on the scan button 42, so that a reduction can be made in the load to the medium 51 when the medium 51 is pulled.

The scan button 42 of the image reading apparatus 1 already described detects whether or not the scan button 42 has been pressed. However, the scan button 42 may be replaced with another input unit that detects occurrence of an event different from a press. The input unit is, for example, a communication device that connects an information processing apparatus outside the image reading apparatus 1 to the control device 43 for information transmission. In this case, when the input unit receives a previously determined conveyance start instruction from the information processing apparatus, the control device 43 performs the processing from Step S7 to Step S12. In this case, the image reading apparatus 1 enables a reduction in the load to the medium 51 and a reduction in manufacturing cost.

The conveyance unit 3 of the medium conveyance device according to the embodiment includes the pair of feed-side rollers 8 that supports a portion of the medium 51, the portion being disposed in the feed-side support region 34, and the pair of ejection-side rollers 7 that supports a portion of the medium 51, the portion being disposed in the ejection-side support region 33. The feed-side support region 34 is disposed downstream of the position detection region 37 in the feed direction 31 in the conveyance path 6. The ejection-side support region 33 is disposed upstream of the position detection region 37 in the feed direction 31 in the conveyance 6. In this case, even when the medium 51 is conveyed in the feed direction 31 or in the ejection direction 32 such that the feed-side end 52 and the ejection-side end 53 pass through the position detection region 37, the medium conveyance device according to the embodiment can support the medium 51 properly with the pair of feed-side rollers 8 or the pair of ejection-side rollers 7. Thus, the medium conveyance device according to the embodiment can convey the medium 51 properly in the feed direction 31 or in the ejection direction 32.

The medium conveyance device according to the embodiment further includes the medium insertion sensor 22 that detects whether or not the medium 51 is disposed in the insertion detection region 36 upstream of the ejection-side support region 33 in the feed direction 31 in the conveyance path 6. In response to detection of the medium 51 by the medium insertion sensor 22 with the conveyance unit 3 having not conveyed the medium 51, the control device 43 controls the conveyance unit 3 to convey the medium 51 in the feed direction 31. In this case, the medium conveyance device according to the embodiment disables the conveyance unit 3 from driving before insertion of the medium 51 into the insertion/ejection opening 5, so that a reduction can be made in power consumption.

The medium conveyance device according to the embodiment further includes the conveyance motor 41 that rotates the pair of ejection-side rollers 7 and the pair of feed-side rollers 8. The control device 43 stops the conveyance motor 41 at the ejection-time motor-stop timing corresponding to the rear-end passage timing of no detection of the medium 51 by the medium position sensor 23 with the conveyance unit 3 conveying the medium 51 in the ejection direction 32. In this case, the medium conveyance device according to the embodiment enables minimization of the time during which the conveyance motor 41 is driving after ejection of the medium 51, so that a reduction can be made in power consumption. With the medium position sensor 23 for use in acquisition of the ejection-time motor-stop timing, the medium conveyance device according to the embodiment can detect whether the medium 51 has been pulled. Thus, due to the medium position sensor 23 serving to detect whether the medium 51 has been pulled, the medium conveyance device according to the embodiment enables a reduction in manufacturing cost without an increase in the number of components.

The medium conveyance device according to the embodiment further includes the reading unit 21 that performs reading in order to read an image on a portion of the medium 51, the portion being disposed in the reading region 35. The reading region 35 is disposed between the position detection region 37 and the ejection-side support region 33 in the conveyance path 6. The control device 43 controls the reading unit 21 to start reading at the reading start timing corresponding to the front-end passage timing of detection of the medium 51 by the medium position sensor 23 with the conveyance unit 3 conveying the medium 51 in the ejection direction 32. Furthermore, the control device 43 controls the reading unit 21 to terminate the reading at the reading termination timing corresponding to the rear-end passage timing of no detection of the medium 51 by the medium position sensor 23 with the conveyance unit 3 conveying the medium 51 in the ejection direction 32. In this case, the medium conveyance device according to the embodiment enables reading at a proper timing, so that an image on the medium 51 can be read properly. With the medium position sensor 23 for use in acquisition of the timing at which reading is performed, the medium conveyance device according to the embodiment can detect whether the medium 51 has been pulled. Thus, due to the medium position sensor 23 serving to detect whether the medium 51 has been pulled, the medium conveyance device according to the embodiment enables a reduction in manufacturing cost without an increase in the number of components.

The medium insertion sensor 22 of the image reading apparatus 1 already described optically detects the medium 51. However, the medium insertion sensor 22 may be replaced with another medium insertion sensor that detects the medium 51 with a means different from optical means. For example, such a medium insertion sensor includes a movable portion blocking the conveyance path 6 in the insertion detection region 36 and detects, in response to movement of the movable portion by a medium being conveyed along the conveyance path 6, whether or not the medium is disposed in the insertion detection region 36. The medium position sensor 23 optically detects the medium 51. However, the medium position sensor 23 may be replaced with another medium position sensor that detects the medium 51 with a means different from optical means, similarly to the medium insertion sensor 22. Even in a case where the medium insertion sensor 22 and the medium position sensor 23 each detect the medium 51 with a means different from optical means, the image reading apparatus 1 enables a reduction in the load to the medium 51 and a reduction in manufacturing cost.

In Step S3 and in Step S5, the image reading apparatus 1 already described detects, with the medium position sensor 23, whether or not the medium 51 is disposed in the position detection region 37 but may detect, with the reading unit 21, whether or not the medium 51 is disposed in the reading region 35. For example, in Step S3, the control device 43 controls the reading unit 21 to monitor whether or not the medium 51 is disposed in the reading region 35. When it is detected that the medium 51 is disposed in the reading region 35, with the conveyance roller 11 and the conveyance roller 16 in forward rotation, the control device 43 performs the processing from Step S4. In Step S5, the control device 43 controls the reading unit 21 to monitor whether or not the medium 51 is disposed in the reading region 35. When it is detected that no medium 51 is disposed in the reading region 35, with the conveyance roller 11 and the conveyance roller 16 remaining stopped, the control device 43 performs the processing from Step S13. In this case, the image reading apparatus 1 enables a reduction in the load to the medium 51 and a reduction in manufacturing cost.

The medium conveyance device according to the embodiment already described is used in the image reading apparatus 1 but may be used in a different apparatus. The different apparatus is, for example, a printer that prints characters/figures on a medium. For the printer, the reading unit 21 already described is replaced with a printing unit that prints characters/figures on a medium being conveyed along the conveyance path 6. In this case, similarly to the image reading apparatus 1 already described, the medium conveyance device according to the embodiment enables a reduction in the load to the medium 51 and a reduction in manufacturing cost.

A medium conveyance device according to the disclosure enables a reduction in the load to a medium being pulled from the device and a reduction in manufacturing cost.

All examples and conditional language recited herein are intended for pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although the embodiments of the disclosure have been described in detail, it should be understood that the various changes, substitutions, and alterations could be made hereto without departing from the spirit and scope of the disclosure.

What is claimed is:

1. A medium conveyance device comprising:
a conveyor configured to convey a medium along a conveyance path;
a first sensor configured to detect whether or not the medium is disposed in a detection region in the conveyance path; and
a controller configured to control the conveyor to convey the medium in an ejection direction opposite to a feed direction when the conveyor conveys the medium in the feed direction and when the first sensor no longer detects the medium, wherein
the controller controls the conveyor to convey the medium in the ejection direction when the conveyor keeps the medium stopped and when the first sensor no longer detects the medium.

2. The medium conveyance device according to claim 1, wherein
the controller controls the conveyor to stop the medium when the conveyor conveys the medium in the feed direction and when the first sensor detects the medium is disposed in the detection region.

3. The medium conveyance device according to claim 2, further comprising an input unit that detects a conveyance start instruction, wherein
the controller controls the conveyor to convey the medium in the feed direction when the conveyor keeps the medium stopped and when the input unit detects the conveyance start instruction.

4. The medium conveyance device according to claim 1, wherein
the conveyor includes:
a pair of feed-side rollers that supports a portion of the medium, the portion being disposed in a feed-side region; and
a pair of ejection-side rollers that supports a portion of the medium, the portion being disposed in an ejection-side region,
the feed-side region is disposed downstream of the detection region in the feed direction in the conveyance path, and
the ejection-side region is disposed upstream of the detection region in the feed direction in the conveyance path.

5. The medium conveyance device according to claim 4, further comprising a second sensor configured to detect whether or not the medium is disposed in another detection region upstream of the ejection-side region in the feed direction is the conveyance path, wherein
the controller controls the conveyor to convey the medium in the feed direction when the conveyor does not convey the medium and when the second sensor detects the medium.

6. The medium conveyance device according to claim 4, further comprising a motor that rotates the pair of ejection-side rollers and the pair of feed-side rollers, wherein
the controller stops the motor at a motor stop timing corresponding to a rear-end passage timing at which the sensor no longer detects the medium when the conveyor conveys the medium in the ejection direction.

7. The medium conveyance device according to claim 4, further comprising a reader configured to perform reading to read an image on a portion of the medium, the portion being disposed in a reading region, wherein
the reading region is disposed between the detection region and the ejection-side region in the conveyance path, and
the controller
controls the reader to start the reading at a reading start timing corresponding to a front-end passage timing at which the first sensor detects the medium when the conveyor conveys the medium in the ejection direction, and
controls the reader to terminate the reading at a reading termination timing corresponding to a rear-end passage timing at which the sensor no longer detects the medium when the conveyor conveys the medium in the ejection direction.
